(19) United States
(12) Patent Application Publication
(10) Pub. No.: US 2024/0282925 A1
(43) Pub. Date: Aug. 22, 2024

(54) NEGATIVE ELECTRODE AND RECHARGEABLE LITHIUM BATTERY INCLUDING SAME

(71) Applicant: SAMSUNG SDI CO., LTD., Yongin-si (KR)

(72) Inventors: Yookyung KIM, Yongin-si (KR); Changsu SHIN, Yongin-si (KR); Youngugk KIM, Yongin-si (KR); Jaehou NAH, Yongin-si (KR); Young-Min KIM, Yongin-si (KR); Sunil PARK, Yongin-si (KR); Eunji KANG, Yongin-si (KR); Doori OH, Yongin-si (KR); Jongmin WON, Yongin-si (KR)

(21) Appl. No.: 18/386,333

(22) Filed: Nov. 2, 2023

(30) Foreign Application Priority Data
Feb. 15, 2023 (KR) 10-2023-0020230
Apr. 26, 2023 (KR) 10-2023-0054901

(51) Int. Cl. H01M 4/36; H01M 4/133; H01M 4/134; H01M 10/0525

(52) U.S. Cl. CPC H01M 4/366; H01M 4/133; H01M 4/134; H01M 10/0525; H01M 2004/027

(57) ABSTRACT

A negative electrode and a rechargeable lithium battery including the negative electrode, the negative electrode including a current collector, a negative active material layer, and a functional layer between the current collector and the negative active material layer or on the negative active material layer, the functional layer including nanometal and nanocarbon.

### CROSS-REFERENCE TO RELATED APPLICATION

This application claims priority to and the benefit of Korean Patent Application No. 10-2023-0020230 filed in the Korean Intellectual Property Office on Feb. 15, 2023, and Korean Patent Application No. 10-2023-0054901 filed in the Korean Intellectual Property Office on Apr. 26, 2023, the entire contents of which are incorporated herein by reference.

### BACKGROUND

### 1. Field

Embodiments are directed to negative electrodes and rechargeable lithium batteries including the same.

### 2. Description of the Related Art

Recently, with a rapid spread of electronic devices such as mobile phones, laptop computers, electric vehicles, and the like, a demand for small, lightweight, and relatively high-capacity rechargeable batteries are rapidly increasing. In particular, since rechargeable lithium batteries with high energy density and excellent efficiency are required, research on improving active mass density of negative electrodes is being required.

### SUMMARY

Embodiments are directed to a negative electrode, including a current collector, a negative active material layer, and a functional layer between the current collector and the negative active material layer or on the negative active material layer, the functional layer having nanometal and nanocarbon. In an implementation, the functional layer is between the current collector and the negative active material layer. In another implementation, the functional layer is on the negative active material layer. In an implementation, the nanometal is Ag, Pt, Al, Zn, Au, Mg, Ge, Cu, In, Ni, Bi, or a combination thereof. In an implementation, an amount of the nanometal is about 1 wt % to about 50 wt % based on 100 wt % of the functional layer. In an implementation, a mixing ratio of the nanometal and the nanocarbon is about 10:90 to about 40:60 weight ratio. In an implementation, the functional layer has a thickness greater than or equal to about 50 nm. In an implementation, the functional layer has a thickness of about 50 nm to about 20 μm. In an implementation, the nanocarbon is carbon black, acetylene black, Ketjen black, Denka black, carbon nanotubes, canon nanofibers, graphite, or a combination thereof. In an implementation, the functional layer further includes a binder.

Embodiments are directed to a rechargeable lithium battery, including a negative electrode, a positive electrode, and an electrolyte, the negative electrode, having a current collector, a negative active material layer, and a functional layer between the current collector and the negative active material layer or on the negative active material layer, the functional layer containing nanometal and nanocarbon. In an implementation of the rechargeable lithium battery, the functional layer is between the current collector and the negative active material layer. In another implementation, the functional layer is on the negative active material layer. In another implementation, the nanometal is Ag, Pt, Al, Zn, Au, Mg, Ge, Cu, In, Ni, Bi, or a combination thereof. In another implementation, an amount of the nanometal is about 1 wt % to about 50 wt % based on 100 wt % of the functional layer. In another implementation, a mixing ratio of the nanometal and the nanocarbon is about 10:90 to about 40:60 weight ratio. In another implementation, the functional layer has a thickness greater than or equal to about 50 nm. In another implementation, the functional layer has a thickness of about 50 nm to about 20 μm. In another implementation, the nanocarbon is carbon black, acetylene black, Ketjen black, Denka black, carbon nanotubes, canon nanofibers, graphite, or a combination thereof. In another implementation, the functional layer further includes a binder.

Some example embodiments provide a negative electrode exhibiting excellent cycle-life characteristics and rate capability.

Some example embodiments provide a rechargeable lithium battery including the negative electrode.

Some example embodiments provide a negative electrode including a current collector; a negative active material layer; and a functional layer including nanometal and nanocarbon, wherein the functional layer is disposed between the current collector and the negative active material layer or on the negative active material layer.

Some example embodiments provide a rechargeable lithium battery including the negative electrode; a positive electrode; and an electrolyte.

The negative electrode according to some example embodiments may exhibit excellent cycle-life characteristics and rate capability.

### BRIEF DESCRIPTION OF THE DRAWINGS

Features will become apparent to those of skill in the art by describing in detail exemplary embodiments with reference to the attached drawings, in which:

FIG. 1 is a schematic diagram showing a negative electrode according to embodiments;

FIG. 2 is a schematic diagram showing a negative electrode according to embodiments; and

FIG. 3 is a schematic, perspective view of a rechargeable lithium battery according to embodiments.

### DETAILED DESCRIPTION

Example embodiments will now be described more fully hereinafter with reference to the accompanying drawings; however, they may be embodied in different forms and should not be construed as limited to the embodiments set forth herein. As these embodiments are exemplary, the present invention is not limited thereto, and these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer is referred to as being “between” two layers, it can be the only layer between the two layers, or one or more intervening layers may also be present. In addition, “layer” herein includes not only a shape formed on the whole surface when viewed from a plan view, but also a shape formed on a partial surface.

The terminology used herein is used to describe embodiments only, and is not intended to limit the present disclosure. The singular expression includes the plural expression unless the context clearly dictates otherwise.

As used herein, “a combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

Herein, “or” is not to be construed as an exclusive meaning, for example, “A or B” is construed to include A, B, A+B, and the like.

As used herein, if a definition is not otherwise provided, a particle diameter or size may be an average particle diameter. This average particle diameter means the average particle diameter (D50), which means a diameter (D50) of particles having a cumulative volume of 50 volume % in a particle size distribution. The average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light-scattering method, performing data analysis, counting the number of particles for each particle size range, and calculating from this.

A negative electrode for a rechargeable lithium battery according to some example embodiments includes a current collector, a negative active material layer, and a functional layer. The functional layer may include or contain nanometal and nanocarbon.

The functional layer may be between the current collector and the negative active material layer, or may be on the negative active material layer.

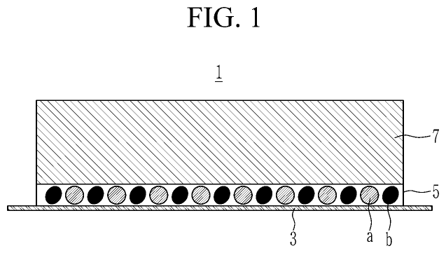

Referring to FIG. 1, a negative electrode 1 according to embodiments may include a current collector 3, a functional layer 5, and a negative active material layer 7 in sequential configuration. The negative active material layer 7 may be on the functional layer 5.

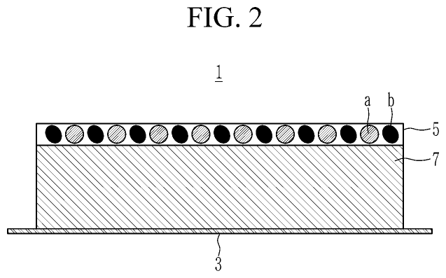

Referring to FIG. 2, a negative electrode 1 according to some example embodiments may include a current collector 3, a negative active material layer 7, and a functional layer 5 in sequential configuration. The functional layer 5 may be on the negative active material layer 7,

As shown in FIGS. 1 and 2, the functional layer 5 may include or contain nanometal (a) and nanocarbon (b).

Because the functional layer including or containing the nanometal is included in the negative electrode, conductivity may be improved. Also, because the functional layer includes or contains nanometals, additional capacities may be obtained due to these nanometals. Even if the density of the active material layer is low, an appropriate capacity may be exhibited.

In addition, the metal included or contained in the functional layer is a nanometal having a nanometer size, and reactivity is more excellent if it has a nanometer size. In the negative electrode according to some example embodiments, the metal included or contained in the functional layer has a lithium ion diffusion rate higher than that of lithium metal. In particular, if the metal is nanometer-sized, the lithium ion diffusion rate is more improved.

Because the functional layer including or containing the nanometal having an excellent lithium ion diffusion rate is included in the negative electrode, lithium ions moving to the negative electrode can be well diffused during charging and discharging.

If the functional layer including or containing the nanometal is included in the negative electrode, the effect of increasing the lithium ion diffusion rate may be more effective in the case if the functional layer including or containing the nanometal is between the current collector and the negative active material layer, as shown in FIG. 2.

If the functional layer is between the current collector and the negative active material layer as shown in FIG. 1, lithium ions that have moved to the negative electrode during charging and discharging are not deposited, that is precipitated on the surface of the negative active material layer, but pass through the negative active material layer and quickly move to the functional layer. In addition, since lithium ions can quickly pass through the functional layer, it is possible to more effectively prevent a phenomenon in which a short circuit occurs by virtue of the lithium ions passing through the separator and coming into contact with the positive electrode, and thereby improve life-cycle characteristics. In addition, since lithium ions that have accumulated between the current collector and the functional layer move to the positive electrode during charging and discharging, this may contribute to the charging and discharging capacity, and thereby improve capacity.

The nanometal size is appropriate if it is in nanometers in size to improve reactivity and may be, for example, several nanometers to hundreds of nanometers. A preferred size of the nanometal may be about 1 nm to about 100 nm, about 20 nm to about 100 nm, or about 40 nm to about 100 nm.

In the nanometal, the metal may be Ag, Pt, Al, Zn, Au, Mg, Ge, Cu, In, Ni, Bi, or a combination thereof, or may be Ag, Al, or a combination thereof.

Si is not preferred to be used as the metal of the nanometal, because Si has almost no metallic properties, has almost no conductivity and a low lithium ion diffusion rate, and cannot play a role in causing lithium precipitation to occur between the current collector and the functional layer. Thus, Si may not be suitable as a metal of the nanometal.

In addition, if the nanometal is used in a metal compound form, e.g., a metal oxide, even though the metal compound may have a nano size, because the metal compound may have no conductivity and may not play a role in causing lithium precipitation to occur between the current collector and the functional layer, the metal compound form may not be suitable for use as a nanometal.

Carbon, particularly nanocarbon included in the functional layer may enable and enhance uniform charging and discharging. The nanocarbon may be carbon black, acetylene black, ketjen black, denka black, carbon nanotubes, canon nanofibers, graphite, or a combination thereof.

The size of nanocarbon is a nanometer size, e.g., it may be several nm to hundreds of nanometers. Preferred size of the nanocarbon may be about 10 nm to about 100 nm, and more preferably may be about 20 nm to about 60 nm.

In some example embodiments, an amount of the nanometal may be about 1 wt % to about 50 wt %, for example about 10 wt % to about 40 wt % based on 100 wt % of the functional layer. If the amount of the nanometal is within the above range, the effect of increasing capacity due to the use of the nanometal may be further improved without causing a volume expansion problem during charging and discharging.

In some example embodiments, a preferred mixing ratio of the nanometal and the nanocarbon may be about 10:90 to about 40:60 weight ratio, and more preferably about 15:85 to about 40:60 weight ratio.

The functional layer may further include a binder. The binder may be an aqueous binder including, e.g., a cellulose-based compound, a styrene-butadiene rubber, an acrylated styrene-butadiene rubber, an acrylonitrile-butadiene rubber, an acrylic rubber, a butyl rubber, an ethylene oxide-containing polymer, polyvinylpyrrolidone, polypropylene, an ethylene propylene copolymer, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenol resin, an epoxy resin, polyvinyl alcohol, polyacrylic acid, or a combination thereof. The cellulose-based compound may include, e.g., one or more of carboxymethyl cellulose, hydroxypropylmethyl cellulose, methyl cellulose, or an alkali metal salt thereof. The alkali metal may be, e.g., Na, K, or Li.

The cellulose-based compound may also serve as a thickener capable of imparting viscosity.

An preferred amount of the nanocarbon may be about 1 wt % to about 50 wt %, and more preferably about 10 wt % to about 40 wt % based on 100 wt % of the functional layer. In addition, a preferred amount of the binder may be about 1 wt % to about 50 wt %, and more preferably about 10 wt % to about 40 wt % based on 100 wt % of the functional layer.

The functional layer may have a thickness of greater than or equal to about 50 nm, about 50 nm to about 20 μm, or about 50 nm to about 10 μm. If the thickness of the functional layer is within the above ranges, an increase in capacity due to the inclusion of the functional layer may be better realized and obtained, and an effect of rapid charging and capacity characteristic improvement may be further increased.

In some example embodiments, a thickness of the negative active material layer may be appropriately adjusted as suitable and necessary and may not need to be limited.

The negative active material layer includes a negative active material. The negative active material may include, e.g., a material that reversibly intercalates/deintercalates lithium ions, a lithium metal, a lithium metal alloy, a material capable of doping/dedoping lithium, or a transition metal oxide.

A material that reversibly intercalates/deintercalates lithium ions may include, e.g., a carbon material, and may be any generally used carbon-based negative active material in a rechargeable lithium ion battery, and may include, e.g., crystalline carbon, amorphous carbon or a mixture thereof.

Crystalline carbon may be in the form of an unspecified-shape, a sheet, flake, spherical, or fiber-shaped natural graphite or artificial graphite, and amorphous carbon may be in the form or a soft carbon, a hard carbon, a mesophase pitch carbonized product, sintered cokes, and like materials.

A material capable of doping/dedoping lithium may include, e.g., Si, a Si—C composite, SiOₓ (0<x<2), a Si-Q alloy (wherein Q is an element selected from, e.g., an alkali metal, an alkaline-earth metal, a Group 13 element, a Group 14 element, a Group 15 element, a Group 16 element, a transition metal, a rare earth element, and a combination thereof, and is not Si), Sn, SnO₂, a Sn—R alloy (wherein R is an element selected from, e.g., an alkali metal, an alkaline-earth metal, a Group 13 element, a Group 14 element, a Group 15 element, a Group 16 element, a transition metal, a rare earth element, and a combination thereof, and is not Sn), and the like, and at least one of these materials may be mixed with SiO₂. Q and R may be selected from, e.g., Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The Si—C composite may include silicon particles and crystalline carbon. The Si—C composite may further include an amorphous carbon layer formed on at least a portion thereof. The Si—C composite may include secondary particles in which primary silicon particles and crystalline carbon are agglomerated, i.e., an agglomerated product, and an amorphous carbon coating layer on a surface of the agglomerated product. Amorphous carbon may be used to fill in between the agglomerated products and surround the surface of the primary particles.

According to some example embodiments, the Si—C composite may be a composite of silicon and amorphous carbon. According to some example embodiments, the Si—C composite may include a silicon-based material and amorphous carbon coated on a surface of the silicon-based material. For example, the Si—C composite may include secondary particles in which primary silicon particles are agglomerated, and an amorphous carbon coating layer on the surface of the secondary particles. The amorphous carbon may also be between the primary silicon particles, so that, for example, the primary silicon particles may be coated with amorphous carbon.

The secondary particles are located in the center of the Si—C composite, which may be referred to as the core and a center portion. In addition, the amorphous carbon coating layer may be referred to as a shell or an outer portion.

In some example embodiments, an average particle diameter (D50) of the silicon primary particles may be about 10 nm to about 30 μm, for example about 10 nm to about 1,000 nm, and in some example embodiments, about 20 nm to about 150 nm. If the average particle diameter of the silicon primary particles is within the above ranges, volume expansion during charging and discharging may be suppressed, and disconnection of a conductive path due to particle crushing during charging and discharging may be prevented.

If coated with the amorphous carbon, a thickness of the coating layer of the amorphous carbon may be about 5 nm to about 100 nm.

Amounts of silicon particles, crystalline carbon, and amorphous carbon in the Si—C composite may be appropriately adjusted.

In some example embodiments, the Si—C composite and crystalline carbon may be mixed and used as the negative active material, and in this case, a mixing ratio thereof may be appropriately adjusted as needed or preferred.

In regard to the negative active material layer, an amount of the negative active material may be about 95 wt % to about 98 wt % based on 100 wt % of the negative active material layer.

The negative active material layer may include a binder and may further include a conductive material. An amount of the binder may be about 1 wt % to about 5 wt % based on 100% by weight of the negative active material layer. An amount of the conductive material may be about 1 wt % to about 5 wt % based on 100 wt % of the negative active material layer.

The binder serves to firmly attach the negative active material particles to each other and also to firmly attach the negative active material to the current collector. The binder may be a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluoro rubber, an ethylene oxide-containing polymer, polyvinyl pyrrolidone, polypropylene, polyepicrohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

If the aqueous binder is used as a negative electrode binder, a cellulose-based compound may be further added to provide viscosity as a thickener. The cellulose-based compound includes, e.g., one or more of carboxymethyl cellulose, hydroxypropylmethyl cellulose, methyl cellulose, or alkali metal salts thereof. The alkali metal may be, e.g., Na, K, or Li. An amount of the thickener may be about 0.1 part by weight to about 3 parts by weight based on 100 parts by weight of the negative active material.

The conductive material is used to impart conductivity to the electrode, and any material may be used as long as it does not cause chemical change in the battery to be configured and is an electron conductive material. Examples of the conductive material may include a carbon-based material including, e.g., natural graphite, artificial graphite, carbon black, acetylene black, Ketjen black, a carbon fiber, and the like; a metal-based material of a metal powder or a metal fiber including, e.g., copper, nickel, aluminum, silver, and the like; a conductive polymer such as a polyphenylene derivative; or a mixture thereof.

The current collector may be, e.g., a copper foil, a nickel foil, a stainless steel foil, a titanium foil, a nickel foam, a copper foam, a polymer substrate coated with a conductive metal, and a combination thereof.

Embodiments of a negative electrode for a rechargeable lithium battery may be prepared by coating a functional layer composition on a current collector followed by drying to form a functional layer, and coating a negative active material layer composition, followed by drying and compressing to form a negative active material layer.

The functional layer composition may include nanometal, nanocarbon, a binder, and a solvent. The solvent may be water.

The negative active material layer composition includes a negative active material, a binder, and a solvent, and may optionally further include a conductive material. The solvent may be an organic solvent such as N-methylpyrrolidone, and if an aqueous binder is used as a binder, water may be used.

Some example embodiments provide a rechargeable lithium battery including the negative electrode, a positive electrode, and an electrolyte.

The positive electrode includes a current collector and a positive active material layer formed on the current collector.

The positive active material may include lithiated intercalation compounds that reversibly intercalate and deintercalate lithium ions. In one or more embodiments, one or more composite oxides of a metal selected from cobalt, manganese, nickel, and a combination thereof, and lithium may be used. For example, a compound represented by any one of the following chemical formulas may be used. LiₐA_{1-b}X_{b}D¹₂ (0.90≤a≤1.8, 0 b≤0.5); LiₐA_{1-b}X_{b}O_{2-c1}D¹_{cl} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0≤α≤2); LiₐNi_{1-b-c}Co_{b}X_{c}O_{2-α}T_{α}, (0.90≤a≤1.8, 0≤b≤0.5, 0≤c≤0.5, 0≤α≤2); LiₐNi_{1-b-c}Co_{b}X_{c}O_{2-α}T₂ (0.90<a<1.8, 0≤b≤0.5, 0≤c≤0.5, 0≤α≤2); LiₐNi_{1-b-c}Mn_{b}X_{c}D^{1α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f})Fe₂(PO₄)₃ (0≤f≤2); and LiₐFePO₄ (0.90≤a≤1.8)

In the above chemical formulas, A may be selected from Ni, Co, Mn, and a combination thereof; X may be selected from Al, Ni, Co, Mn, Cr, Fe, Mg, Sr, V, a rare earth element, and a combination thereof; D¹ may be selected from O, F, S, P, and a combination thereof, E may be selected from Co, Mn, and a combination thereof, T may be selected from F, S, P, and a combination thereof; G may be selected from Al, Cr, Mn, Fe, Mg, La, Ce, Sr, V, and a combination thereof, Q may be selected from Ti, Mo, Mn, and a combination thereof, Z may be selected from Cr, V, Fe, Sc, Y, and a combination thereof, J may be selected from V, Cr, Mn, Co, Ni, Cu, and a combination thereof, and L¹ may be selected from Mn, Al, and a combination thereof.

The compounds may have a coating layer on the surface, or may be mixed with another compound having a coating layer. The coating layer may include at least one coating element compound including, e.g., an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be used in a method having no adverse influence on properties of a positive active material by using these elements in the compound. In an implementation, the method may include any coating method (e.g., spray coating, dipping, etc.), and further details or drawings are not necessary since it is well-known to those of skill in the art.

In the positive electrode, an amount of the positive active material may be about 90 wt % to about 98 wt % based on the total weight of the positive active material layer.

In some example embodiments, the positive active material layer may further include a binder and a conductive material. In this case, the amounts of the binder and the conductive material may be about 1 wt % to about 5 wt %, respectively, based on a total weight of the positive active material layer.

The binder serves to firmly attach the positive active material particles to each other and also to firmly attach the positive active material to the current collector. Examples of suitable binders include, e.g., polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Suitable conductive materials may include a carbon-based material, e.g., natural graphite, artificial graphite, carbon black, acetylene black, Ketjen black, a carbon fiber, and the like; a metal-based material of a metal powder or a metal fiber including, e.g., copper, nickel, aluminum, silver, and the like; a conductive polymer such as a polyphenylene derivative; or a mixture thereof.

The current collector may include Al, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include, e.g., a carbonate-based, ester-based, ether-based, ketone-based, alcohol-based, or aprotic solvent.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include, e.g., methyl acetate, ethyl acetate, n-propyl acetate, dimethylacetate, methylpropionate, ethylpropionate, decanolide, mevalonolactone, caprolactone, and the like. The ether-based solvent may include, e.g., dibutyl ether, tetraglyme, diglyme, dimethoxyethane, 2-methyltetrahydrofuran, and the like. The ketone-based solvent may include cyclohexanone and the like. The alcohol-based solvent may include ethanol, isopropyl alcohol, and the like and the aprotic solvent may include, e.g., nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The organic solvents may be used alone or in combination with one or more, and the mixing ratio if used in combination with one or more organic solvents may be appropriately adjusted according to the desired battery performance, as may be understood by those of skill in the art.

In addition, in the case of the carbonate-based solvent, it may be desirable to use a mixture of cyclic carbonate and chain carbonate. In this case, if the cyclic carbonate and the chain carbonate are mixed in a volume ratio of about 1:1 to about 1:9, the performance of the electrolyte may be improved.

The organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound of Chemical Formula 1.

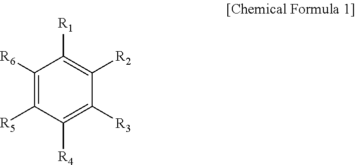

In Chemical Formula 1, R₁ to R₆ are the same or different and are selected from hydrogen, a halogen, a C1 to C10 alkyl group, a haloalkyl group, and a combination thereof.

Specific examples of the aromatic hydrocarbon-based organic solvent include, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include an additive of vinylethyl carbonate, vinylene carbonate or an ethylene carbonate-based compound of Chemical Formula 2 in order to improve a cycle-life of a battery as an additive.

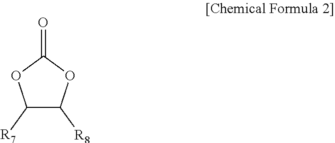

In Chemical Formula 2, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not hydrogen.

Examples of the ethylene carbonate-based compound may include, e.g., difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving a cycle-life may be within an appropriate range as needed or preferred.

The lithium salt dissolved in an organic solvent supplies a battery with lithium ions, basically operates the rechargeable lithium battery, and improves transportation of the lithium ions between positive and negative electrodes. Examples of the lithium salt include at least one supporting salt including, e.g., LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein, x and y are natural numbers, for example an integer ranging from 1 to 20, lithium difluoro(bisoxolato) phosphate, LiCl, LiI, LiB(C₂O₄)₂ (lithium bis(oxalato) borate: LiBOB), and lithium difluoro(oxalato)borate (LiDFOB). A concentration of the lithium salt may range from about 0.1 M to about 2.0 M. If the lithium salt is included at the stated concentration range, an electrolyte may have excellent performance and lithium ion mobility due to optimal electrolyte conductivity and viscosity.

The rechargeable lithium battery may further include a separator between the negative electrode and the positive electrode, depending on a type of the battery. Examples of a suitable separator material include, e.g., polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

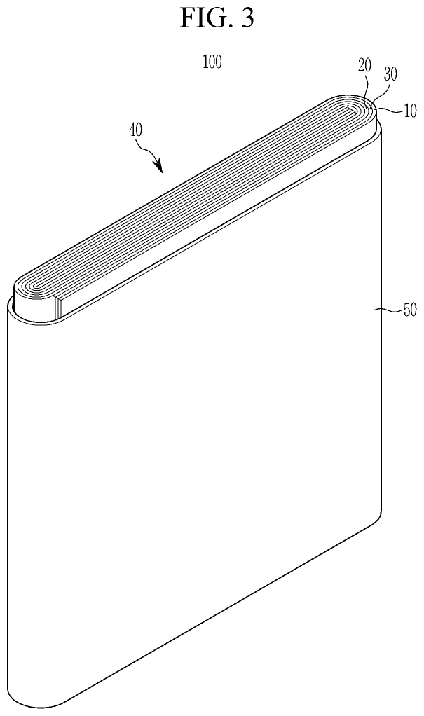

FIG. 3 is a schematic, partial cut-away, perspective view of a rechargeable lithium battery according to embodiments. The rechargeable lithium battery is illustrated as a prismatic battery but is not limited thereto and may include variously-shaped batteries such as a cylindrical battery, a pouch battery, and other forms.

Referring to FIG. 3, a rechargeable lithium battery 100 according to some example embodiments includes an electrode assembly 40 manufactured by winding a separator 30 interposed between a positive electrode 10 and a negative electrode 20, and a case 50 housing the electrode assembly 40. An electrolyte (not shown) may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

30 wt % of Ag having an average particle diameter (D50) of 100 nm, 55 wt % of Denka black having an average particle diameter (D50) of 50 nm, and 15 wt % of a carboxymethyl cellulose binder were mixed in a water solvent to prepare functional layer slurry.

Negative active material layer slurry was prepared by mixing 97.5 wt % of a negative active material of artificial graphite and silicon-carbon composite (in a mixing weight ratio=89:11), 1 wt % of carboxymethyl cellulose, and 1.5 wt % of a styrene butadiene rubber in a water solvent.

The silicon-carbon composite had a core including silicon nanoparticles and a soft carbon coating layer formed on the core surface. Herein, an amount of the silicon nanoparticles was 40 wt % based on a total weight of the silicon-carbon, and an amount of the amorphous carbon was 60 wt %. The soft carbon coating layer had a thickness of 20 nm, and the silicon nanoparticles had an average particle diameter (D50) of 100 nm.

The functional layer slurry was coated on a Cu foil current collector and dried to form a functional layer. The negative active material layer slurry was coated on the functional layer and then dried and pressurized to form a negative active material layer to manufacture a negative electrode.

In the manufactured negative electrode, the functional layer had a thickness of 5 μm, and the negative active material layer had a thickness of 35 μm. In addition, the negative active material layer had an active mass density of 1.5 g/cm³.

The negative electrode was used with a lithium metal counter electrode and an electrolyte to manufacture a half-cell. The electrolyte was prepared by dissolving 1 M LiPF₆ in a mixed solvent of ethylene carbonate, ethylmethyl carbonate, and diethyl carbonate (a volume ratio of 2:1:7) and adding 3.5 wt % of fluoroethylene carbonate based on a total weight of the mixed solvent.

In addition, the negative electrode and the electrolyte were used with a LiNi_{0.88}Co_{0.11}Al_{0.01}O₂ positive electrode to manufacture a coin-type full cell.

### Example 2

A negative electrode was manufactured in the same manner as in Example 1 except that the functional layer slurry was prepared by mixing 30 wt % of Ag having an average particle diameter (D50) of 50 nm, 55 wt % of Denka black having an average particle diameter (D50) of 50 nm, and 15 wt % of a carboxymethyl cellulose binder in a water solvent. In the manufactured negative electrode, a functional layer had a thickness of 5 μm, and a negative active material layer had a thickness of 35 μm. In addition, the negative active material layer had an active mass density of 1.5 g/cm³.

The negative electrode was used in the same manner as in Example 1 to manufacture a half-cell and a coin-type full cell.

### Example 3

A negative electrode was manufactured in the same manner as in Example 1 except that the functional layer slurry was prepared by mixing 15 wt % of Ag having an average particle diameter (D50) of 50 nm, 70 wt % of Denka black having an average particle diameter (D50) of 50 nm, and 15 wt % of a carboxymethyl cellulose binder in a water solvent. In the manufactured negative electrode, a functional layer had a thickness of 5 μm, and a negative active material layer had a thickness of 35 μm. In addition, the negative active material layer had an active mass density of 1.5 g/cm³.

The negative electrode was used in the same manner as in Example 1 to manufacture a half-cell and a coin-type full cell.

### Example 4

A negative electrode was manufactured in the same manner as in Example 1 except that the negative active material layer slurry of Example 2 was coated and dried on a Cu foil current collector to form a negative active material layer, and the functional layer slurry was coated thereon and then dried and compressed to form a functional layer.

The negative electrode was used in the same manner as in Example 1 to manufacture a half-cell and a coin-type full cell.

### Comparative Example 1

97.5 wt % of a negative active material of artificial graphite and silicon-carbon composite (in a mixing weight ratio=89:11), 1 wt % of carboxymethyl cellulose, and 1.5 wt % of a styrene butadiene rubber were mixed in a water solvent to prepare a negative active material layer slurry.

The negative active material layer slurry was coated on a Cu foil current collector and then dried and compressed to form a negative active material layer and thereby manufacture a negative electrode. In the manufactured negative electrode, the negative active material layer had a thickness of 43 μm. In addition, the negative active material layer had an active mass density of 1.6 g/cm³.

The negative electrode was used with a lithium metal counter electrode and an electrolyte to manufacture a half-cell. The electrolyte was prepared by dissolving 1 M LiPF₆ in a mixed solvent of ethylene carbonate, ethylmethyl carbonate, and diethyl carbonate (in a volume ratio of 2:1:7) and adding 3.5 wt % of fluoroethylene carbonate to a total weight of the mixed solvent.

In addition, the negative electrode and the electrolyte were used with a LiNi_{0.88}Co_{0.11}Al_{0.01}O₂ positive electrode to manufacture a coin-type full cell.

### Comparative Example 2

A negative electrode was manufactured in the same manner as in Example 1 except that the functional layer slurry was prepared by mixing 70 wt % of Denka black with an average particle diameter (D50) of 50 nm and 30 wt % of a carboxymethyl cellulose binder. In the manufactured negative electrode, a functional layer had a thickness of 5 μm, and a negative active material layer had a thickness of 35 μm. In addition, the negative active material layer had an active mass density of 1.5 g/cm³.

The negative electrode was used in the same manner as in Example 1 to manufacture a half-cell and a coin-type full cell.

### Comparative Example 3

77.5 wt % of a negative active material of artificial graphite and silicon-carbon composite (in a mixing weight ratio=89:11), 1 wt % of carboxymethyl cellulose, 1.5 wt % of a styrene butadiene rubber, 5 wt % of Ag having an average particle diameter (D50) of 50 nm, and 15 wt % of Denka black having an average particle diameter (D50) of 50 nm were mixed in a water solvent to prepare a negative active material layer slurry.

The negative active material layer slurry was used in the same manner as in Example 1 to manufacture a negative electrode.

The manufactured negative electrode was used in the same manner as in Example 1 to manufacture a half-cell and coin-type full cell.

### Experimental Example 1) Evaluation of Efficiency Characteristics

Each of the half-cells according to Examples 1 to 3 and Comparative Examples 1 to 3 was once charged and discharged at 0.1 C. A ratio of discharge capacity to charge capacity thereof was calculated. The results are provided as efficiency in Table 1.

### Experimental Example 2) Evaluation of Rapid Charging Rate Capability

Each of the half-cells according to Examples 1 to 3 and Comparative Examples 1 to 3 was once charged and discharged at 0.2 C and once charged and discharged at 1 C. A ratio of charge capacity at 1 C to charge capacity at 0.2 C was calculated. The results are shown as a rapid charging ratio in Table 1.

### Experimental Example 3) Evaluation of Cycle-Life Characteristics

The coin-type full cells according to Examples 1 to 3 and Comparative Examples 1 to 3 were 100 times charged and discharged at 1 C. A ratio of the 100^{th}discharge capacity to the 1^{st} discharge capacity was calculated, and the results are shown as capacity retention in Table 1.

### Experimental Example 4) CFC (Coin Full Cell) Sharp Drop Point

The coin-type full cells according to Examples 1 to 3 and Comparative Examples 1 to 3 were 500 times charged and discharged under the following charge and discharge conditions.
Charge: 1.0 C/cut-off: 4.0 V, 0.05 C
Discharge: 1.0 C/cut-off: 2.5 V

A ratio of discharge capacity at each cycle to discharge capacity at the 1^{st} cycle was calculated. The number of cycles at which the discharge capacity ratio decreased to 85% or less is shown in Table 1.

TABLE 1

| | | | Rapid | | CFC sharp |
|---|---|---|---|---|---|
| | Specific | | charging | Capacity | drop |
| | capacity | Efficiency | ratio | retention | point |
| | (mAh/g) | (%) | (%) | (%) | (cyc.) |
| Example 1 | 505 | 92 | 78 | 98 | 350 |
| Example 2 | 505 | 92 | 78 | 98 | 400 |
| Example 3 | 502 | 91 | 77 | 94 | 380 |
| Example 4 | 481 | 86 | 75 | 98 | 210 |
| Comparative | 499 | 91 | 76 | 95 | 210 |
| Example 1 | | | | | |
| Comparative | 497 | 90 | 75 | 94 | 210 |
| Example 2 | | | | | |
| Comparative | 472 | 84 | 73 | 30 | 3 |
| Example 3 | | | | | |

As shown in Table 1, the cells of Examples 1 to 3 exhibited very excellent capacity retention as well as high specific capacity, efficiency, and rapid charge and discharge characteristics. In addition, the cell of Example 4 exhibited a little low specific capacity but very excellent capacity retention. In particular, the cells of Examples 1 to 3 well maintained discharge capacity to at least the 350^{th} charge and discharge.

On the contrary, the cell 1 including no functional layer according to Comparative Example 1 and the cell having a functional layer including nanocarbon alone according to Comparative Example 2 exhibited low specific capacity and sharply dropped discharge capacity at the 210^{th} charge and discharge cycle.

In addition, the cell using nanometal and nanocarbon in a negative active material layer according to Comparative Example 3 exhibited a little low rapid charging and discharge characteristics, very low specific capacity and efficiency, and significantly deteriorated capacity retention. In particular, the cell of Comparative Example 3 exhibited sharply dropped discharge capacity even at the 3^{rd} charge and discharge.

In order to increase the capacity, a high active mass negative electrode should be manufactured, and problems caused by strong pressurization for manufacturing such a high active mass negative electrode can be prevented. If, however, the pressurizing is performed strongly, the active material layer may be pressed excessively, and the active material layer may become too dense. It is difficult for lithium ions to pass through such a dense active material layer to move in the direction of the current collector, and thus lithion ions accumulate on the surface of the active material layer to form lithium dendrites, resulting in deterioration of rate capability and cycle-life characteristics.

Although the preferred embodiments of the present invention have been described through the above, the present invention is not limited thereto, and can be implemented by various modifications within the scope of the claims and detailed description and the accompanying drawings, which also fall within the scope of the present embodiments.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A negative electrode, comprising
a current collector;
a negative active material layer; and
a functional layer between the current collector and the negative active material layer or on the negative active material layer, the functional layer containing nanometal and nanocarbon.

2. The negative electrode as claimed in claim 1, wherein the functional layer is between the current collector and the negative active material layer.

3. The negative electrode as claimed in claim 1, wherein the functional layer is on the negative active material layer.

4. The negative electrode as claimed in claim 1, wherein the nanometal is Ag, Pt, Al, Zn, Au, Mg, Ge, Cu, In, Ni, Bi, or a combination thereof.

5. The negative electrode as claimed in claim 1, wherein an amount of the nanometal is about 1 wt % to about 50 wt % based on 100 wt % of the functional layer.

6. The negative electrode as claimed in claim 1, wherein a mixing ratio of the nanometal and the nanocarbon is about 10:90 to about 40:60 weight ratio.

7. The negative electrode as claimed in claim 1, wherein the functional layer has a thickness greater than or equal to about 50 nm.

8. The negative electrode as claimed in claim 7, wherein the functional layer has a thickness of about 50 nm to about 20 μm.

9. The negative electrode as claimed in claim 1, wherein the nanocarbon is carbon black, acetylene black, Ketjen black, Denka black, carbon nanotubes, canon nanofibers, graphite, or a combination thereof.

10. The negative electrode as claimed in claim 1, wherein the functional layer further includes a binder.

11. A rechargeable lithium battery, comprising:
the negative electrode as claimed in claim 1;
a positive electrode; and
an electrolyte.

12. The rechargeable lithium battery as claimed in claim 11, wherein the functional layer is between the current collector and the negative active material layer.

13. The rechargeable lithium battery as claimed in claim 11, wherein the functional layer is on the negative active material layer.

14. The rechargeable lithium battery as claimed in claim 11, wherein the nanometal is Ag, Pt, Al, Zn, Au, Mg, Ge, Cu, In, Ni, Bi, or a combination thereof.

15. The rechargeable lithium battery as claimed in claim 11, wherein an amount of the nanometal is about 1 wt % to about 50 wt % based on 100 wt % of the functional layer.

16. The rechargeable lithium battery as claimed in claim 11, wherein a mixing ratio of the nanometal and the nanocarbon is about 10:90 to about 40:60 weight ratio.

17. The rechargeable lithium battery as claimed in claim 11, wherein the functional layer has a thickness greater than or equal to about 50 nm.

18. The rechargeable lithium battery as claimed in claim 17, wherein the functional layer has a thickness of about 50 nm to about 20 μm.

19. The rechargeable lithium battery as claimed in claim 11, wherein the nanocarbon is carbon black, acetylene black, Ketjen black, Denka black, carbon nanotubes, canon nanofibers, graphite, or a combination thereof.

20. The rechargeable lithium battery as claimed in claim 11, wherein the functional layer further includes a binder.
